(19) United States
(12) Patent Application Publication
(10) Pub. No.: US 2025/0333346 A1
(43) Pub. Date: Oct. 30, 2025

(54) METHODS OF PRODUCTION AND USE OF RARE EARTH ENHANCED COAGULANTS

(71) Applicant: SePRO Corporation, Carmel, IN (US)

(72) Inventors: Byran C. FUHRMANN, Rocky Mount, NC (US); Pamela DUGAN, Spring Hill, FL (US)

(21) Appl. No.: 19/070,423

(22) Filed: Mar. 4, 2025

Related U.S. Application Data
(60) Provisional application No. 63/639,677, filed on Apr. 28, 2024.

(51) Int. Cl. C02F 11/143; C02F 101/10; C02F 103/00

(52) U.S. Cl. CPC C02F 11/143; C02F 2101/105; C02F 2103/007; C02F 2209/11; C02F 2305/00

(57) ABSTRACT

A formulation of a trivalent coagulant with a smaller amount of water soluble rare earth that provides enhanced removal of turbidity and particulate phosphorus while simultaneously increasing the density of sludge produced after the removal of organic matter from the treated water. In one embodiment, coagulant and rare earth combination formulations include an aluminum coagulant with a smaller amount of lanthanum and cerium salts. In another embodiment, coagulant and rare earth combination formulations include an iron coagulant with a smaller amount of lanthanum and cerium salts.

### CROSS-REFERENCE TO RELATED APPLICATIONS

This application is related to and claims the benefit of U.S. Provisional Patent App. No. 63/639,677, filed Apr. 28, 2024, entitled METHODS OF PRODUCTION AND USE OF RARE EARTH ENHANCED COAGULANTS, the entirety of which is incorporated herein by reference.

### GOVERNMENT RIGHTS STATEMENT

N/A.

### TECHNICAL FIELD

This disclosure relates to methods of production and use of a mixture of rare-earth-containing coagulants for improved removal of particulates suspended in waters such as wastewater or natural surface waters such as lakes, reservoirs, rivers, and coastal marine waters.

### BACKGROUND

Aluminum-based coagulants and iron-based coagulants are extensively used to remove particulates and water quality contaminants from a variety of waters such as lakes and wastewater. These trivalent metal compounds generally work through the process of coagulation in which smaller, negatively charged particles are bound together with the positively charged trivalent cations to form neutral, larger particles or flocs that have a greater density than the water in which they were previously suspended. Polymers, including metal complexes like polyaluminum chloride, also allow for flocculation in which groups of flocs are bound together by a chemical chain that includes multiple positively charged ions. Flocculation typically increases the efficiency of particle removal when combined with coagulation. Polymers are often added to increase the density of the sludge or removed particulate matter that has settled during the wastewater treatment process. Sludge removal and disposal is a costly process in the treatment of wastewater.

In natural surface waters, phosphorus is often a limiting nutrient for algae and invasive aquatic plants. Natural surface waters are often subject to phosphorus input from a variety of sources such as stormwater runoff, treated wastewater effluent, irrigation runoff, and leaky septic tanks. In lake and reservoir management, trivalent metal coagulants such as alum and polyaluminum chloride are commonly used to reduce water column phosphorus concentrations and remove phosphorus containing particulate matter such as algae. The use of these coagulants in surface waters also results in the production of sludge which settles to the bottom of the water body. The production of large volumes of sludge can lead to a loss of water volume in natural surface waters such as lakes and reservoirs.

### SUMMARY

Some embodiments advantageously provide a superior ability to remove particulate phosphorus compounds, such as algae and polyphosphates, from water and also results in an increased density and phosphorus content of sludge. In one embodiment, a method of improving water quality includes: applying a product to a body of water, the product including a mixture of a first amount of a trivalent metal coagulant with a second amount of a rare earth salt, the first amount being greater than the second amount; and reducing turbidity, reducing particulate phosphorus, and/or increasing sludge density by the application of the product to the body of water.

In one aspect of the embodiment, the trivalent metal coagulant includes a first amount of an aluminum coagulant, the first amount being more than 80% of the product by volume or weight; and the rare earth salt includes cerium and/or lanthanum.

In one aspect of the embodiment, the trivalent metal coagulant includes aluminum sulfate and the rare earth salt includes a combination of cerium and lanthanum chloride.

In one aspect of the embodiment, the trivalent metal coagulant includes aluminum chlorohydrate and the rare earth salt includes a combination of cerium and lanthanum chloride.

In one aspect of the embodiment, the trivalent metal coagulant includes an aluminum salt, an iron salt, polyaluminum chloride, and/or aluminum chlorohydrate.

In one aspect of the embodiment, the first amount of the trivalent metal coagulant is an acidic trivalent metal coagulant solution and the second amount of the rare earth salt is an acidic liquid rare earth solution, the first amount of the trivalent metal coagulant and the second amount of the rare earth salt being in a homogenous mixture.

In one embodiment, a product for improving water quality includes a mixture of a first amount of a trivalent metal coagulant and a second amount of a rare earth salt, the first amount being greater than the second amount.

In one aspect of the embodiment, the first amount of the trivalent metal coagulant includes an aluminum coagulant, the first amount being more than 80% of the product by volume or weight; and the second amount of the rare earth salt includes cerium and/or lanthanum.

In one aspect of the embodiment, the product causes a reduction in turbidity, a reduction in particulate phosphorus, and an increase in sludge density when applied to a body of water.

In one aspect of the embodiment, the trivalent metal coagulant includes aluminum sulfate and the rare earth salt includes a combination of cerium and lanthanum chloride.

In one aspect of the embodiment, the trivalent metal coagulant includes aluminum chlorohydrate and the rare earth salt includes a combination of cerium and lanthanum chloride.

In one embodiment, a product for improving water quality includes: a mixture of an iron-based coagulant with a smaller amount of a rare earth salt, the mixture including: a first amount of an iron coagulant, the first amount comprising more than 90% of the composition by volume or weight; and a second amount of a rare earth salt, the rare earth salt comprising of cerium and/or lanthanum.

In one aspect of the embodiment, the product causes a reduction in turbidity, a reduction in particulate phosphorus, and an increase in sludge density when applied to a body of water.

In one aspect of the embodiment, the iron coagulant includes ferrous sulfate and the rare earth salt includes a combination of cerium and lanthanum chloride.

In one aspect of the embodiment, the iron-based coagulant is a liquid formulation of liquid ferric sulfate.

In one aspect of the embodiment, the rare earth salt is a liquid rare earth chloride solution.

In one aspect of the embodiment, the first amount of an iron coagulant and the second amount of the rare earth salt are in a homogenous mixture.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a graph showing the total percent increase in the turbidity reduction, total phosphorus removal, and sludge density of three rare earth and coagulant combinations compared to what would be expected based on the additive benefits of each component applied separately.

FIG. 2 is a graph showing the relative percent increase in the turbidity reduction, total phosphorus removal, and sludge density of three rare earth and coagulant combinations compared to what would be expected based on the additive benefits of each component applied separately.

### DETAILED DESCRIPTION

This disclosure relates to products and methods of production and use of a mixture of rare-earth-containing coagulants for improved removal of particulates suspended in waters such as wastewater or natural surface waters such as lakes, reservoirs, rivers, and coastal marine waters. These rare-earth-containing coagulants show an enhanced efficiency in the removal of particulates, removal of total phosphorus, and an increase in the density of the sludge or particulate matter that is removed from the overlaying water. Such compositions generally include a mixture of a small percentage of rare earth salts and a greater percentage of trivalent metal coagulants, the rare earth salts including, but not limited to, aluminum salts, iron salts, and the trivalent metal polymers including, but not limited to, polyaluminum chloride and aluminum chlorohydrate. In some embodiments, the mixture may be a homogenous blend of solids that are directly added to the water being treated. In some embodiments, the mixture may be a stabilized liquid mixture. In some embodiments, the two different components may be added simultaneously, such as in liquid and/or solid form. The products disclosed herein advantageously provide an improvement in the ability to remove contaminants from surface waters while minimizing sludge production. The products disclosed herein also advantageously provide an increase in sludge density and contaminant concentration, which results in a decreased requirement for sludge transportation and processing and, consequently, an increase in operational efficiency and improvement in economic feasibility of the process.

In one embodiment, a product for improving water quality is a rare earth and coagulant combination product. In one embodiment, the rare earth and coagulant combination product is a combination of a rare earth salt and a coagulant (which is also referred to herein as “rare earth/coagulant combination product” for simplicity) as disclosed herein displays a superior ability to reduce the turbidity in the water to which it is applied, to remove particulate phosphorus from the water column, and that results in sludge that is denser than sludge that results from application of either individual component alone.

In some embodiments, the formulation is a homogenous mixture of an acidic liquid rare earth solution and an acidic trivalent metal coagulant solution. In some embodiments, the formulation is a homogenous mixture of water-soluble rare-earth salts and water-soluble trivalent cation coagulants salts or trivalent cation polymers. In some embodiments, a liquid rare earth solution and a liquid trivalent cation coagulant solution are applied to water as a treatment to produce a desired effect, either simultaneously or in close sequence. In some embodiments, a solid rare earth component and a solid trivalent cation coagulant component are applied to water as a treatment to produce a desired effect, either simultaneously or in close sequence.

In one embodiment, the amount of the coagulant in the rare earth/coagulant combination product is greater than the amount of the rare earth salt in the rare earth/coagulant combination product. For example, in one embodiment, the coagulant makes up more than 80% of the rare earth/coagulant combination product by volume or weight. In one embodiment, the coagulant makes up more than 90% of the rare earth/coagulant combination product by volume or weight.

In one embodiment, the rare earth salt is a rare earth solution or water soluble salt. In one embodiment, the rare earth solution or water soluble salt includes cerium. In one embodiment, the rare earth solution or water soluble salt includes lanthanum. In one embodiment, the rare earth solution or water soluble salt includes both cerium and lanthanum. In one non-limiting example, the rare earth solution or water soluble salt includes cerium chloride and/or lanthanum chloride. In one embodiment, the rare earth salt is an acidic liquid rare earth solution.

In one embodiment, the coagulant is a trivalent metal coagulant being a salt. In one embodiment, the trivalent metal coagulant salt includes aluminum, with an associated anion that includes, but is not limited to, chloride or sulfate. In one embodiment, the trivalent metal coagulant salt includes ferric iron, with an associated anion that includes, but is not limited to, chloride or sulfate. In one embodiment, the trivalent metal coagulant is a polymer. In one embodiment, the trivalent metal coagulant polymer is poly aluminum chloride. In one embodiment, the trivalent metal coagulant is aluminum chlorohydrate. In one embodiment, the coagulant is an acidic trivalent metal coagulant solution.

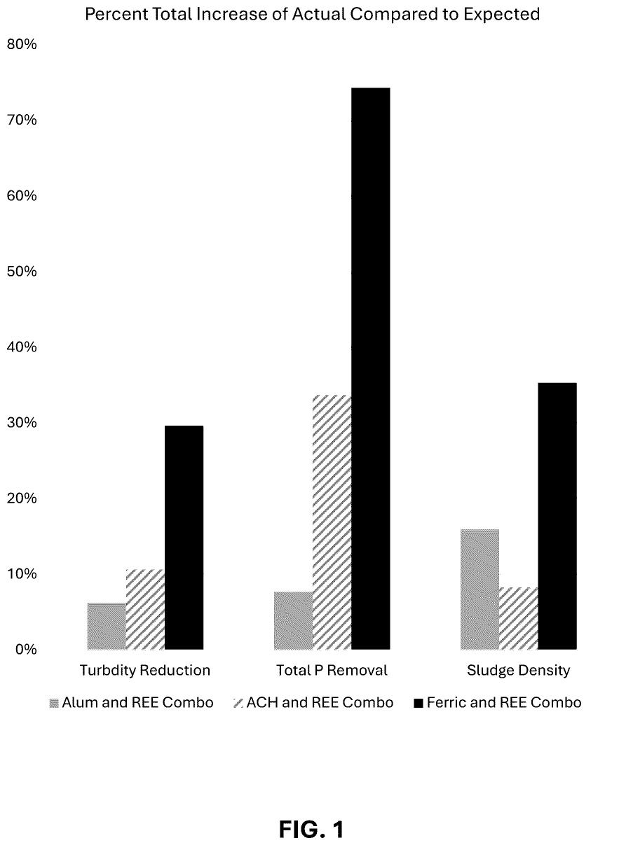

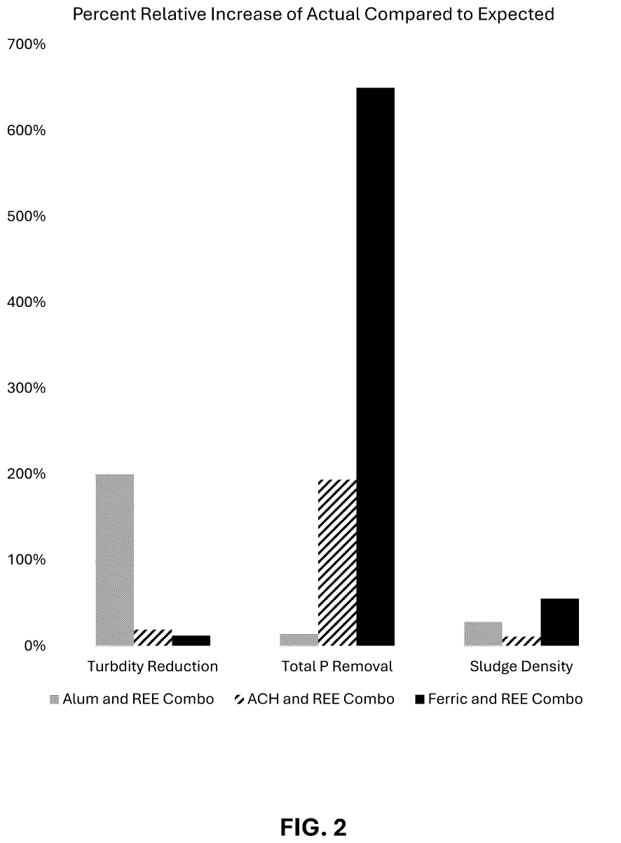

As is discussed in greater detail below, the rare earth/coagulant combination product is more effective in improving water quality in surface waters than either the rare earth component or the coagulant component alone. Therefore, the rare earth component and the coagulant act synergistically (have a synergistic effect). Thus, in some embodiments, it can be said that the rare earth/coagulant combination product includes a first amount of a coagulant and a synergistically effective second amount of a rare earth component. The percent total increase in each of turbidity reduction, total phosphorus removal, and sludge density for three rare earth/coagulant combination products (alum and REE combination, ACH and REE combination, and ferric and REE combination) are shown in FIG. 1. The percent relative increase in each of turbidity reduction, total phosphorus removal, and sludge density for three rare earth/coagulant combination products (alum and REE combination, ACH and REE combination, and ferric and REE combination) are shown in FIG. 2.

### EXPERIMENT PROTOCOL

The same experimental protocol was used for each of Examples 1-3, discussed below. A Phipps & Bird™ (Phipps & Bird, Inc.) Six-Paddle Stirrer model 7790-910, designed to meet ASTM standard method D 2035 for Coagulation-Flocculation Jar Test, was used and included six, two-liter beakers in each test. In each jar test procedure, approximately 13 L of algae-rich water was homogenized and used to fill each two-liter beaker. The remaining water from each jar test was kept as the untreated control. All six two-liter beakers were dosed before the jar test procedure, with two beakers receiving the coagulant only dose, two beakers receiving the rare earth only dose, and two beakers receiving the rare earth/coagulant combination product dose. The jar test procedure was included 100 rotations per minute for 1 minute (mixing), at 30 rotations per minute for 20 minutes (flocculation), and 0 rotations per minute for 15 minutes (settling). After the settling period, 10 mL of water was taken from the surface of the beaker (surface sample) and 10 ml of water was taken from six inches below the surface of the water in each beaker (subsurface sample). The surface and subsurface samples from the two beakers with the same treatment were composited into one 40-mL sample. The 40-mL sample was homogenized and the remaining water that was kept as the untreated control was homogenized and a 40-mL aliquot was removed, so that four 40-mL samples remained after each jar test experiment.

The turbidity of a homogenized aliquot of all four samples was measured using a Sper Scientific® (Sper Scientific Instruments LLC, Arizona, United States) turbidity meter that meets IXO 7027 standards (model 860040). The turbidity reduction was calculated by subtracting the turbidity of each treatment from the turbidity of the untreated control and dividing this number by the turbidity of the untreated control. A 10 mL aliquot of the homogenized sample was separated and filtered using a 0.45 um Nylon filter. Another 10 mL aliquot of the homogenized sample was separated and digested using the acid persulfate digestion described in EPA method 365.3. Both the filtered sample and the digested samples were analyzed for phosphate content using EPA Method 365.3, which included a colorimetric reaction and analysis on a spectrophotometer, with a detection limit of 10 ug-P/L. The filtered sample results are considered dissolved orthophosphate and the digested sample results are considered total phosphorus. All filtered samples, both treated and untreated, had dissolved phosphate concentrations below the detection limit of 10 ug-P/L in each experiment, indicating that essentially all phosphorus was in the particulate form, either in the organic phosphorus or polyphosphorus compounds. The percent reduction in total phosphorus was calculated by subtracting the total phosphorus concentration of each treatment from the total phosphorus concentration of the untreated control and dividing this number by the total phosphorus concentration of the untreated control. When the total phosphorus concentration of a treated sample was below the detection limit, one-half of the detection (5 ug-P/L) was used in the calculation.

The sludge height in each beaker was measured and the average height of the sludge in the two beakers with the same treatment was used to calculate the average volume of sludge for the treatment by multiplying the average height of sludge (in cm) by the area of the beaker bottom (121 cm², 11 cm×11 cm). Once measurements and water samples were taken, the surface and mid-water was decanted and discarded so that only the sludge and a small amount of overlaying water remained in each jar test beaker. The sludge from both beakers for each treatment was decanted into a pre-weighed 500 mL glass beaker, which was dried at 103° C. and weighed afterwards on a microscale. The sludge weight was calculated by difference and divided by two for the average sludge weight in each beaker. The sludge density was calculated by dividing the average mass of sludge for each treatment by the average sludge volume for each treatment.

### Example 1

In a first non-limiting example (Example 1), the rare earth/coagulant combination product is a homogenous liquid formulation of liquid aluminum sulfate (alum) and a concentrated liquid rare earth chloride (“REE chloride”) solution. The alum has a density of approximately 1.33 g/mL and is 4.4% elemental aluminum by weight. The REE chloride is approximately 15.4% elemental cerium and 7.7% elemental lanthanum by weight with a density of approximately 1.55 g/mL. Various mixtures containing mostly alum and smaller quantities of REE chloride were produced by simply pipetting a known volume of each liquid together into a 50-mL centrifuge tube to produce a total mixture volume of 40 mL and briefly shaking. Mixtures included 20% REE chloride, 10% REE chloride, 5% REE chloride, 3% REE chloride, 2% REE chloride, and 1% REE chloride, with the other portion of the composition being alum in each mixture. These mixtures were placed on a shelf and allowed to sit undisturbed at room temperature for one month next to solutions of pure alum and pure REE chloride. All mixtures except 1% REE chloride produced a substantial precipitate at the bottom of the centrifuge container. The 1% REE chloride, 99% alum solution did not produce a substantial precipitate, only an amount comparable to the precipitation observed in pure alum and pure REE chloride. Therefore, the 1% REE chloride and 99% alum solution was considered to be stable for the purpose of operation storage when the intention of use is within one month of mixing.

According to the experimental protocol described above and using the volumetric ratio found to be stable (1% REE chloride and 99% alum), 198 μL of liquid alum was added to each of the two coagulant only beakers (“Alum Only”), 200 μL of a 1:100 diluted sample of the concentrated liquid rare earth chloride solution (2 μL equivalent) was added to each of the two rare earth only beakers (“REE Only”), and 198 μL of liquid alum and 200 μL of a 1:100 diluted sample of the concentrated liquid rare earth chloride solution was added to each of the rare earth and coagulant combination beakers (“Alum & REE Combination”). The homogenized solution was not used in the experiment due to the difference in the density of the liquid mixture and the density of the concentrated liquid rare earth chloride solution, which may have led to a slightly different dose of REE in the combination treatment. The average turbidity, total phosphorus (total P), and sludge properties of each sample of this jar test are shown in Table 1. The expected reduction in turbidity and total phosphorus for the Alum & REE Combination treatment were both calculated by adding together the reductions observed for Alum only and REE only. The expected sludge density for the Alum & REE Combination treatment was equal to the Alum Only treatment sludge density, since the REE Only treatment did not result in the production of a measurable amount of sludge. The increase in turbidity reduction, total phosphorus reduction, and sludge density was calculated by subtracting the expected value for each parameter from the actual observed value. These values are shown in Table 2. These data show there was a synergistic improvement in the reduction in turbidity, and synergistic increase in the sludge density, while there was also slight synergy in the total phosphorus reduction.

TABLE 1
Results of Alum Only, REE Only, and Alum & REE Combination treatments.

| | | | Sludge | Sludge | Sludge | Sludge | | |
|---|---|---|---|---|---|---|---|---|
| | Turbidity | Total P | Height | Volume | Weight | Density | Turbidity | Total P |
| Sample | (NTU) | (μg/L) | (cm) | (cm³) | (mg) | (mg/cm³) | Reduction | Reduction |
| Control | 3.2 | 39 | N/A | | | | | |
| Alum Only | 3.0 | 31 | 0.22 | 26.6 | 15 | 0.56 | 6% | 21% |
| REE Only | 3.3 | 26 | 0.00 | 0.0 | 0 | N/A | −3% | 33% |
| Alum & REE | 2.9 | 15 | 0.16 | 19.4 | 14 | 0.72 | 9% | 62% |

TABLE 2
Comparison of actual and expected turbidity reduction, total
phosphorus reduction, and sludge density for the alum and REE
Combination treatments.
Alum & REE Combination

| | | |
|---|---|---|
| Turbidity Reduction | Expected | 3% |
| | Actual | 9% |
| | Increase | 6% total (200% relative) |
| | Result | Synergy |
| Total P Reduction | Expected | 54% |
| | Actual | 62% |
| | Increase | 8% total (14% relative) |
| | Result | Slight Synergy |
| Sludge Density | Expected | 0.56 mg/cm³ |
| | Actual | 0.72 mg/cm³ |
| | Increase | 0.16 mg/cm³ |
| | Result | Synergy |

### Example 2

In a second non-limiting example (Example 2), the rare earth/coagulant combination is a homogenous liquid formulation of liquid aluminum chlorohydrate (ACH) and a concentrated liquid rare earth chloride (REE chloride) solution. The liquid ACH has a density of approximately 1.33 g/mL and is 12.5% elemental aluminum by weight. The concentrated liquid rate earth chloride solution is approximately 15.4% elemental cerium and 7.7% elemental lanthanum by weight with a density of approximately 1.55 g/mL. Various mixtures containing mostly ACH and smaller quantities of REE chloride were produced by simply pipetting a known volume of each liquid together into a 50 mL centrifuge tube to produce a total mixture volume of 40 mL and briefly shaking. Mixtures included 20% REE chloride, 10% REE chloride, 5% REE chloride, 3% REE chloride, 2% REE chloride, and 1% REE chloride, with the other portion of the composition being ACH in each mixture. These mixtures were placed on a shelf and allowed to sit undisturbed at room temperature for one month next to solutions of pure ACH and pure REE chloride. All mixtures except 20% REE chloride did not produce a substantial precipitate at the bottom of the centrifuge container, only amounts comparable to the precipitation observed in pure alum and pure REE chloride. Therefore, the 10% REE chloride and 90% ACH, the 5% REE chloride and 95% ACH, the 3% REE chloride and 97% ACH, the 2% REE chloride and 98% ACH, and the 1% REE chloride and 99% ACH solutions were considered to be stable for the purpose of operation storage when the intention of use is within one month of mixing.

According to the experimental protocol described above and using the volumetric ratio found to be stable with the highest concentration of REE chloride (90% ACH and 10% REE chloride), 45 μL of liquid ACH was added to each of the two coagulant only beakers (“ACH Only”), 500 μL of a 1:100 diluted sample of the concentrated liquid rare earth chloride solution (5 μL equivalent) was added to each of the two rare earth only beakers (“REE Only”), and 45 μL of liquid ACH and 500 μL of a 1:100 diluted sample of the concentrated liquid rare earth chloride solution was added to each of the rare earth and coagulant combination beakers (“ACH & REE Combination”). The homogenized solution was not used in the experiment due to the difference in the density of the liquid mixture and the density of the concentrated liquid rare earth chloride solution, which may have led to a slightly different dose of REE in the combination treatment. The average turbidity, total phosphorus (total P), and sludge properties of each sample of this jar test are shown in Table 3. The expected reduction in turbidity and total phosphorus for the ACH & REE Combination treatment were both calculated by adding together the reductions observed for Alum Only and REE Only treatments. The expected sludge density for the ACH & REE Combination treatment was equal to the ACH Only treatment sludge density, since the REE Only treatment did not result in the production of a measurable amount of sludge. The increase in turbidity reduction, total phosphorus reduction, and sludge density was calculated by subtracting the expected value for each parameter from the actual observed value. These values are shown in Table 4. These data show there was a very substantial increase (substantial synergistic improvement) in total phosphorus, a synergistic increase in the sludge density, and a slight increase (slight synergy) in the turbidity reduction.

TABLE 3
Results of ACH Only, REE Only, and ACH & REE Combination treatments.

| | | | Sludge | Sludge | Sludge | Sludge | | |
|---|---|---|---|---|---|---|---|---|
| | Turbidity | Total P | Height | Volume | Weight | Density | Turbidity | Total P |
| Sample | (NTU) | (μg/L) | (cm) | (cm³) | (mg) | (mg/cm³) | Reduction | Reduction |
| Control | 4.7 | 92 | | | | | | |
| ACH Only | 2.5 | 79 | 0.2 | 24.2 | 18 | 0.74 | 47% | 14% |
| REE Only | 4.3 | 89 | 0 | 0 | 0 | N/A | 9% | 3% |
| ACH & REE | 1.6 | 45 | 0.28 | 33.9 | 28 | 0.83 | 66% | 51% |

TABLE 4
Comparison of actual and expected turbidity reduction,
total phosphorus reduction, and sludge density for the
ACH and REE Combination treatments.
ACH & REE Combination

| | | |
|---|---|---|
| Turbidity Reduction | Expected | 55% |
| | Actual | 66% |
| | Increase | 11% total (20% relative) |
| | Result | Synergy |
| Total P Reduction | Expected | 17% |
| | Actual | 51% |
| | Increase | 34% total (200% relative) |
| | Result | Substantial Synergy |
| Sludge Density | Expected | 0.74 mg/cm³ |
| | Actual | 0.83 mg/cm³ |
| | Increase | 0.09 mg/cm³ |
| | Result | Slight Synergy |

### Example 3

In a third non-limiting example (Example 3), the rare earth/coagulant combination is a homogenous liquid formulation of liquid ferric sulfate (ferric) and a concentrated liquid rare earth chloride (REE chloride) solution. The ferric has a density of approximately 1.46 g/mL and is 12% elemental iron by weight. The concentrated liquid rate earth chloride solution is approximately 15.4% elemental cerium and 7.7% elemental lanthanum by weight with a density of approximately 1.55 g/mL. Various mixtures containing mostly ferric and smaller quantities of REE chloride were produced by simply pipetting a known volume of each liquid together into a 50 mL centrifuge tube to produce a total mixture volume of 40 mL and briefly shaking. Mixtures included 20% REE chloride, 10% REE chloride, 5% REE chloride, 3% REE chloride, 2% REE chloride, and 1% REE chloride, with the other portion of the composition being ferric in each mixture. These mixtures were placed on a shelf and allowed to sit undisturbed at room temperature for one month next to solutions of pure ferric and pure REE chloride. All mixtures except 20% REE chloride and 10% REE chloride did not produce a substantial precipitate at the bottom of the centrifuge container, only amounts comparable to the precipitation observed in pure alum and pure REE chloride. Therefore, the 5% REE chloride and 95% ferric, the 3% REE chloride and 97% ferric, the 2% REE chloride and 98% ferric, and the 1% REE chloride and 99% ferric solutions were considered to be stable for the purpose of operation storage when the intention of use is within one month of mixing.

According to the experimental protocol described above and using the volumetric ratio found to be stable with the highest concentration of REE chloride (95% ferric and 5% REE chloride), 190 μL of ferric was added to each of the two coagulant only beakers (“Ferric Only”), 100 μL of a 1:10 diluted sample of the concentrated liquid rare earth chloride solution (10 μL equivalent) was added to each of the two rare earth only beakers (“REE Only”), and 190 μL of liquid ferric sulfate and 100 μL of a 1:10 diluted sample of the concentrated liquid rare earth chloride solution was added to each of the rare earth and coagulant combination beakers (“Ferric & REE Combination”). The homogenized solution was not used in the experiment due to the difference in the density of the liquid mixture and the density of the concentrated liquid rare earth chloride solution, which may have led to a slightly different dose of REE in the combination treatment. The average turbidity, total phosphorus (total P), and sludge properties of each sample of this jar test are shown in Table 5. Both the Ferric Only and the Ferric & REE treatments resulted in a noticeable red tint in the treated water. A small portion of the water in each beaker was filtered with a 0.22-μm Nylon filter and the red color remained, indicating that the red color was either due to dissolved iron or nanoparticulate iron compounds. The red color of the treated water resulted in a substantial increase in turbidity for both the Ferric Only and the Ferric & REE treatments when compared to the control. The expected reduction in turbidity and total phosphorus for the Ferric & REE Combination treatment were both calculated by adding the reductions observed for Ferric Only and REE Only together. The expected sludge density for the Ferric & REE combination treatment was equal to the Ferric Only treatment sludge density, since the REE Only treatment did not result in the production of a measurable amount of sludge. The increase in turbidity reduction, total phosphorus reduction, and sludge density was calculated by subtracting the expected value for each parameter from the actual observed value. These values are shown in Table 6. These data show there was a substantial synergistic improvement in the reduction in total phosphorus and increase in the sludge density. There was a noticeable decrease in the increase in the turbidity of the REE & Ferric treatment compared to the addition of the increase in the turbidity of the REE Only and the Ferric Only treatments, which may have been due to synergistic removal of particles, although the red color remained essentially the same as the Ferric Only treatment.

TABLE 5
Results of Ferric Only, REE Only, and Ferric & REE Combination treatments.

| | | | Sludge | Sludge | Sludge | Sludge | | |
|---|---|---|---|---|---|---|---|---|
| | Turbidity | Total P | Height | Volume | Weight | Density | Turbidity | Total P |
| Sample | (NTU) | (μg/L) | (cm) | (cm³) | (mg) | (mg/cm³) | Reduction | Reduction |
| Control | 2.7 | 35 | N/A | | | | | |
| Ferric Only | 8.9 | 31 | 0.22 | 26.6 | 17 | 0.64 | −230% | 11% |
| REE Only | 3.0 | 35 | 0 | 0.0 | 0 | N/A | −11% | 0% |
| Ferric & REE | 8.4 | 5 | 0.15 | 18.2 | 18 | 0.99 | −211% | 86% |

TABLE 6
Comparison of actual and expected turbidity reduction,
total phosphorus reduction, and sludge density for the
ferric and REE Combination treatments.
Ferric & REE Combination

| | | |
|---|---|---|
| Turbidity Reduction | Expected | −241% |
| | Actual | −211% |
| | Increase | 30% total |
| | Result | Potential Synergy |
| Total P Reduction | Expected | 11% |
| | Actual | 86% |
| | Increase | 74% total (673% relative) |
| | Result | Substantial Synergy |
| Sludge Density | Expected | 0.64 mg/cm³ |
| | Actual | 0.99 mg/cm³ |
| | Increase | 0.35 mg/cm³ |
| | Result | Substantial Synergy |

### EMBODIMENTS

In one embodiment, a coagulant for removing phosphorus-rich particles includes: a first amount of a soluble rare earth solution or a salt; and a second amount of an aluminum or iron-based coagulant or polymer.

In one aspect of the embodiment, the rare earth solution is a mixture of cerium and lanthanum chloride.

In one embodiment, the coagulant is a soluble aluminum or iron salt or polymer at a pH less 7.

In one aspect of the embodiment, the aluminum coagulant is aluminum sulfate.

In one aspect of the embodiment, the aluminum coagulant is aluminum chlorohydrate with a basicity of between 50% and 95%.

In one aspect of the embodiment, the iron coagulant is ferric sulfate.

In one embodiment, a method of improving water quality includes: applying a product to a body of water, the product including a mixture of a first amount of a trivalent metal coagulant with a second amount of a rare earth salt, the first amount being greater than the second amount; and reducing turbidity, reducing particular phosphorus, and/or increasing sludge density by the application of the product to the body of water.

In one aspect of the embodiment, the trivalent metal coagulant includes a first amount of an aluminum coagulant, the first amount being more than 80% of the composition by volume or weight; and the rare earth salt includes cerium and/or lanthanum.

In one aspect of the embodiment, the trivalent metal coagulant includes aluminum sulfate and the rare earth salt includes a combination of cerium and lanthanum chloride.

In one aspect of the embodiment, the trivalent metal coagulant includes aluminum chlorohydrate and the rare earth salt includes a combination of cerium and lanthanum chloride.

In one aspect of the embodiment, the trivalent metal coagulant includes an aluminum salt, an iron salt, polyaluminum chloride, and/or aluminum chlorohydrate.

In one aspect of the embodiment, the first amount of the trivalent metal coagulant is an acidic trivalent metal coagulant solution and the second amount of the rare earth salt is an acidic liquid rare earth solution, the first amount of the trivalent metal coagulant and the second amount of the rare earth salt being in a homogenous mixture.

In one embodiment, a product for improving water quality includes: a mixture of a first amount of a trivalent metal coagulant and a second amount of a rare earth salt, the first amount being greater than the second amount.

In one aspect of the embodiment, the first amount of the trivalent metal coagulant includes an aluminum coagulant, the first amount being more than 80% of the composition by volume or weight; and the second amount of the rare earth salt includes cerium and/or lanthanum.

In one aspect of the embodiment, the product demonstrates superior removal of turbidity, particulate phosphorus, and increased sludge density when applied to a body of water.

In one aspect of the embodiment, the trivalent metal coagulant includes aluminum sulfate and the rare earth salt includes a combination of cerium and lanthanum chloride.

In one aspect of the embodiment, the trivalent metal coagulant includes aluminum chlorohydrate and the rare earth salt includes a combination of cerium and lanthanum chloride.

In one embodiment, a product for improving water quality includes: a mixture of an iron-based coagulant with a smaller amount of a rare earth salt, the mixture including: a first amount of an iron coagulant, comprising more than 90% of the composition by volume or weight; and a rare earth salt, comprising of cerium and/or lanthanum.

In one aspect of the embodiment, the product demonstrates superior removal of turbidity, particulate phosphorus, and increased sludge density.

In one aspect of the embodiment, the iron coagulant includes ferrous sulfate and the rare earth salt includes a combination of cerium and lanthanum chloride.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A method of improving water quality, the method comprising:
applying a product to a body of water, the product including a mixture of a first amount of a trivalent metal coagulant with a second amount of a rare earth salt, the first amount being greater than the second amount; and
reducing turbidity, reducing particulate phosphorus, and/or increasing sludge density by the application of the product to the body of water.

2. The method of claim 1, wherein:
the trivalent metal coagulant includes a first amount of an aluminum coagulant, the first amount being more than 80% of the product by volume or weight; and
the rare earth salt includes cerium and/or lanthanum.

3. The method of claim 1, wherein the trivalent metal coagulant includes aluminum sulfate and the rare earth salt includes a combination of cerium and lanthanum chloride.

4. The method of claim 1, wherein the trivalent metal coagulant includes aluminum chlorohydrate and the rare earth salt includes a combination of cerium and lanthanum chloride.

5. The method of claim 1, wherein the trivalent metal coagulant includes an aluminum salt, an iron salt, polyaluminum chloride, and/or aluminum chlorohydrate.

6. The method of claim 1, wherein the first amount of the trivalent metal coagulant is an acidic trivalent metal coagulant solution and the second amount of the rare earth salt is an acidic liquid rare earth solution, the first amount of the trivalent metal coagulant and the second amount of the rare earth salt being in a homogenous mixture.

7. A product for improving water quality, the product comprising:
a mixture of a first amount of a trivalent metal coagulant and a second amount of a rare earth salt, the first amount being greater than the second amount.

8. The product of claim 7, wherein:
the first amount of the trivalent metal coagulant includes an aluminum coagulant, the first amount being more than 80% of the product by volume or weight; and
the second amount of the rare earth salt includes cerium and/or lanthanum.

9. The product of claim 7, wherein the product causes a reduction in turbidity, a reduction in particulate phosphorus, and an increase in sludge density when applied to a body of water.

10. The product of claim 7, wherein the trivalent metal coagulant includes aluminum sulfate and the rare earth salt includes a combination of cerium and lanthanum chloride.

11. The product of claim 7, wherein the trivalent metal coagulant includes aluminum chlorohydrate and the rare earth salt includes a combination of cerium and lanthanum chloride.

12. A product for improving water quality, the product comprising:
a mixture of an iron-based coagulant with a smaller amount of a rare earth salt, the mixture including:
a first amount of an iron coagulant, the first amount comprising more than 90% of the product by volume or weight; and
a second amount of a rare earth salt, the rare earth salt comprising of cerium and/or lanthanum.

13. The product of claim 12, wherein the product causes a reduction in turbidity, a reduction in particulate phosphorus, and an increase in sludge density when applied to a body of water.

14. The product of claim 12, wherein the iron coagulant includes ferrous sulfate and the rare earth salt includes a combination of cerium and lanthanum chloride.

15. The product of claim 12, wherein the iron-based coagulant is a liquid formulation of liquid ferric sulfate.

16. The product of claim 12, wherein the rare earth salt is a liquid rare earth chloride solution.

17. The product of claim 12, wherein the first amount of an iron coagulant and the second amount of the rare earth salt are in a homogenous mixture.
